(19) United States
(12) Patent Application Publication
(10) Pub. No.: US 2005/0179998 A1
(43) Pub. Date: Aug. 18, 2005

(54) Control unit for a microscope

(76) Inventors: Heinz Studer, Blons (AT); Heinz Zimmermann, Balgach (CH); Paul Graefenhain, Balgach (CH)

Correspondence Address: HODGSON RUSS LLP, ONE M & T PLAZA, SUITE 2000, BUFFALO, NY, 14203-2391, US

(21) Appl. No.: 11/111,320

(22) Filed: Apr. 21, 2005

Related U.S. Application Data
(63) Continuation of application No. PCT/EP03/11611, filed on Oct. 20, 2003.

(30) Foreign Application Priority Data
Oct. 22, 2002 (DE) 102 49 177.1

(51) Int. Cl. G21K 7/00

(52) U.S. Cl. 359/368

(57) ABSTRACT

A control unit for controlling functional units of a microscope is preferably constructed in the manner of a computer mouse and comprises a microcontroller; at least one operating element for providing control commands to the microcontroller for actuating or controlling the functional units; and a memory device associated with the microcontroller, wherein the memory device includes a first memory region and a second memory region, the first memory region storing boot loader programming instructions executable to load control programming instructions into the second memory region, the control programming instructions defining a function of the at least one operating element. The invention eliminates the need to open the control unit and remove or reburn the microcontroller, or to make a hardware change using a jumper setting, in order to update the software controlling the control unit.

### CROSS REFERENCE TO RELATED APPLICATIONS

The present application claims benefit under 35 U.S.C. §§ 120 and 365(c) as a continuation of International Application No. PCT/EP2003/011611 filed Oct. 20, 2003 designating the United States. The present application further claims benefit under 35 U.S.C. §§ 119 of German patent application no. 102 49 177.1 filed Oct. 22, 2002, priority of which is claimed in the aforementioned International Application No. PCT/EP2003/011611.

### FIELD OF THE INVENTION

The present invention relates to a manually actuated control unit for a microscope of a type having at least one operating element, such as an operating wheel, an operating key, and/or an operating ball, by means of which a microcontroller of the control unit can be supplied with control commands for actuating or controlling a number of functional units of the microscope.

### BACKGROUND OF THE INVENTION

Motorized microscopes in which system components or functional units for performing at least one motor driven function are provided on a microscope body are already known. An example is the commercially available product “Leica DMLA®” of the applicants. This is a motorized microscope in which important microscope functions such as e.g. the change of magnification, adjustment of lighting or focusing are motorized and can be optimally coordinated by means of microprocessor control. The motorized functions can be controlled by a personal computer or a central electronic control. Moreover, the microscope can be controlled by means of a control device which is separate from the microscope body itself. This control device comprises sensors which are able to deliver analog signals to the above mentioned electronic controls through a line. Because of the spatial separation of the control device from the microscope the latter can be positioned freely and thus, for example, be adjusted to suit the individual build of the user. For example, the MZ16A microscope made by Leica Microsystems (Schweiz) AG, assignee of the present applicantion, is equipped with a CANBus and a decentral intelligence. In other words, microprocessors are incorporated in the functional units and in the control unit and are loaded with specially selected software which ensures both the operation of the actors associated with the particular functional units and also communication of the units with one another. In order to change the software in these functional units the microscope has to be put into loading mode by operating a jumper, i.e. using the hardware. Then the new software is loaded through a serial interface and the jumper is then reset. There is no way of telling whether the software loaded does or does not belong to the functional unit. Therefore, in order to alter the software, the apparatus has to be opened up and there is risk of damage to the apparatus. If the wrong software is loaded, this results in malfunction of the microscope and possibly a laborious investigation looking for the fault. In the control unit, on the other hand, the software is burned onto the processor. To change the software the processor has to be dismantled, erased and re-burned.

It is also known to equip motorized microscopes of this kind with bus systems through which it is possible both for the functional units to communicate with one another for the purpose of carrying out and coordinating the various microscope functions, and for the functional units to communicate with the operating element, by a simple method.

The individual functional units of a motorized microscope of this kind generally have an actor or a command inputting device and a microcontroller which communicates with the actor or the command inputting device and which is constructed or cooperates with a corresponding memory device. As a rule, software or firmware which controls the particular function is stored in this memory unit, and accessed by the microcontroller in order to control the actor associated with it. In conventional systems it is not possible to amend this software or firmware, for example by updating it, except by laboriously opening the functional unit in question, and removing and reburning the microcontroller, or at least making a hardware change using a jumper setting.

The aim of the invention is to provide a motorized microscope the operation and handling of which are improved compared with conventional solutions.

This aim is achieved by a control unit according to the invention characterized in that it comprises a microcontroller and a memory region in which a bootstrap loader software or custom boot loader is stored, and by a microscope equipped with such a control unit.

According to the invention, using the boot strap loader software provided, installation software can easily be downloaded into the microcontroller of the control unit. This installation software then makes it easy to carry out a purely software-related update of the software or firmware of the microcontroller of the control unit, thereby verifying or defining the operating elements, particularly the operating wheels or operating keys or operating ball.

The control unit according to the invention is particularly characterized in that it communicates directly, i.e. without any intermediate signal preparing units, with the other (motorized) functional units of the microscope, via a bus system, so that control commands delivered to the operating element can be executed directed in the microcontrollers of the various functional units. As the control unit according to the invention is particularly easy to program or to set with regard to its operating elements, individualized use of the control unit by a number of users is readily possible.

The microscope which can be operated using the control unit comprises, for example, a motorized zoom unit, a motorized filter wheel, a motorized iris shutter, a motorized closure, a motorized focus, particularly a fine focus, a motorized shutter, a motorized transmitted light base, a motorized light source, a motorized X-Y stage and/or a motorized fluorescence module. Selective combination of these functional units makes it possible to achieve optimum functionality of the microscope according to the invention, all the functional units beings easily controlled by means of the control unit according to the invention.

The control unit according to the invention is expediently formed with at least one manually operated wheel on its side and with at least one manually operated push button on its upper surface. This configuration of the control unit results in good ergonomic design (one handed operation), while the entire functionality of the microscope can be combined in a single control unit. According to the invention, as mentioned previously, the control unit is connected directly to the bus through which the functional units of the microscope communicate with one another. Using the combination of rotary wheels and buttons or keys, all the functional units can easily be freely configured and a plurality of configurations, e.g. individualized configurations, can easily be stored. For example, the fine movement of a zoom and focus can be achieved using the associated first and second rotary wheels and coarse adjustments can be achieved using push buttons. As a result, continuous movements or constant speeds and constantly accelerated movements can be achieved in the course of focusing or using the zoom mechanism. Standardized positions can be taken up using a simple push button or a desired end position can be adopted, for example, by means of a double push button. It is also possible to activate default settings by pressing certain combinations of keys on switching on (e.g. right/left reversal). Moreover, a combination of keys can be used for storing and calling up a system state associated with a particular user, from a ring buffer. These key combinations can also be used in particular to identify individual users.

The shutters provided in a microscope can also be actuated using a key. Moreover, sustained pressure on such a key can be used like a “dimmer switch” for regulatable light sources, thereby increasing or reducing the intensity. A filter revolver operation can easily be carried out using two keys provided for this purpose.

The present status (focus, zoom, filter, iris shutter position, shutter, etc) can be stored for example using only one key by means of a ring buffer, and expediently up to five possible positions can be stored at the same time (for example in an EEPROM).

An iris shutter of a microscope may also be electronically adjusted using a rotary wheel, while a third rotary wheel may be provided for this function, in particular.

Expediently, a software-based adaptation of the focusing speed to the actual magnification of the microscope is provided.

Preferably, the rotary wheels are provided with means for inertia-assisting movement, by means of which the focus or zoom can be actuated with the aid of inertia. For heavy wheels this can be achieved by the fact that these wheels keep on moving automatically once started up.

It is advantageous if the ratio between the speed of movement of the X-Y stage and the speed of movement of the operating element is dependent on the particular zoom magnification selected at that moment.

The control unit according to the invention may be constructed with a built-in magnetic holder in the baseplate for possible resting positions on the microscope itself. This ensures particularly easy positioning or fixing of the control unit on a microscope.

According to a particularly preferred embodiment of the microscope according to the invention the control unit is designed to be capable of being illuminated. The construction of the control unit with a lighting element, for example (the current supply of which may be provided through the bus system, for example) is particularly useful for dark room applications.

According to a preferred embodiment of the control unit according to the invention, at least one control unit is arranged in a control unit base surface such that movement of the control unit over a substrate actuates this operating element.

It is possible, for example, to use relative movement in a baseplate of the control unit relative to a substrate, e.g. a laboratory bench, to control an X-Y stage in the microscope, while this function may be achieved by means of a general switch (proximity sensor, capacitive switch, optical sensor, or the like) incorporated in the baseplate of the control unit or by means of a “mouse-like” ball which is set into the baseplate of the control unit and cooperates with said control unit as it is moved over a substrate. It is particularly advantageous to provide, for example, one of the operating keys as the means by which movement of the control unit over a substrate can selectively be coupled to or uncoupled from the corresponding movement of the X-Y stage. This makes the control unit according to the invention easier to handle as it ensures that the user can adjust the control unit such that not every movement of the control unit over the substrate results in corresponding movement of the X-Y stage of the microscope. This feature can be implemented particularly using a simple push button or key. It may also be advisable to provide a manually operated proximity sensor or proximity switch.

According to another preferred embodiment of the control unit according to the invention it has a magnetic holding device by means of which it can be attached to a microscope. Such a holding device by means of which it can be particularly easily attached to a microscope has proved especially advantageous, particularly in general laboratory use. The control unit according to the invention is particularly characterized in that all the operating elements are manually operable, i.e. without having to remove one's hand from the control unit. Thus, for the first time, all the motorized functional units of a microscope can be substantially fully controlled by means of a control unit for one handed operation. Advantageously, the control unit is also constructed in the form or manner of a computer mouse. Such a shape, which is rounded and fits the user's hand, has proved to be ergonomically very satisfactory.

### BRIEF DESCRIPTION OF THE DRAWINGS

The invention is described more fully with reference to the attached drawings, wherein:

FIG. 1 is a diagrammatic block circuit diagram of a preferred embodiment of a microscope associated with the control unit according to the invention;

FIG. 2 is a block circuit diagram of the individual functional units of a microscope according to FIG. 1 communicating with one another through a bus system;

FIG. 3 is a preferred embodiment of a control unit according to the invention, in plan view; and

FIG. 4 shows the novel control unit according to FIG. 3 viewed from below.

### DETAILED DESCRIPTION OF THE INVENTION

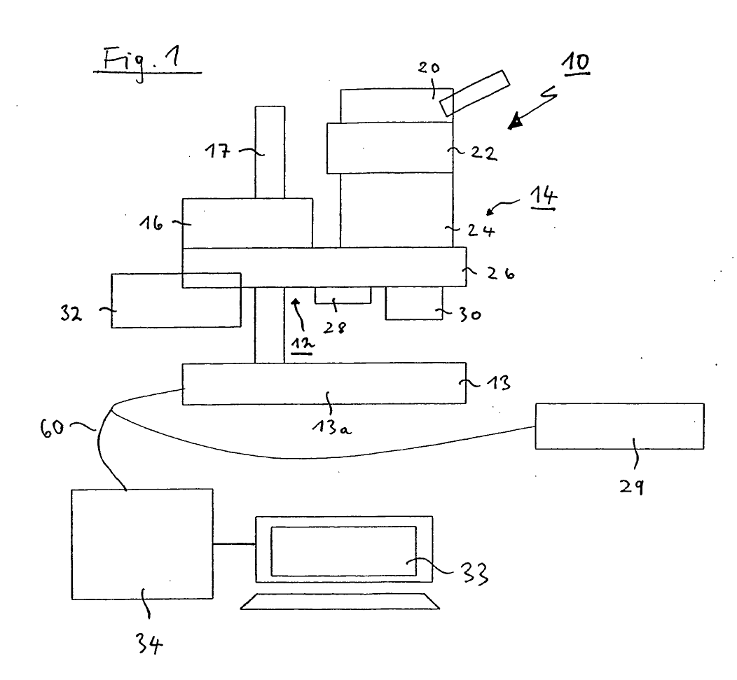

A preferred embodiment of a microscope which can be controlled using the control unit according to the invention is generally designated 10 in FIG. 1. The microscope 10 has an optical device carrier 12 which carries an optical system generally designated 14.

The microscope 10 has a base 13 which is provided with a motorized X-Y stage 13a.

The optical system 14 is movable on a stand 17 using a motorized focusing device 16.

The optical system 14 has an eyepiece 20, an illuminating device constructed particularly as a fluorescence module 22 with a motorized shutter and a motor-adjustable filter wheel, in this case particularly for accommodating at least one fluorescence filter, a motorized zoom 24 and an objective (lens) changer 26 which in the present instance carries two selectable objectives (lenses) 28, 30. The objective changer 26 may optionally also be motor driven.

Instead of the lighting source of the fluorescence module 22 or in addition to it, another illuminating light 32 or a transmitted light base (not shown) may be provided underneath the base 13 with a motor-driven intensity adjustment.

The components 13, 16, 20, 22, 24, 26, 32 shown are functional units of the microscope 10.

These functional units are connected to one another via a bus system (not shown in detail in FIG. 1) and to external devices or functional units. External devices may be, in particular, a manually actuated control unit 29 shown in FIG. 1 and a computer 33 having a universal port 34 or various ports, e.g. USB1, USB2 or IEEE 1394 or RS232. It is possible to control the functional units of the microscope 10 both using the control unit 29 and the computer 33. It is also possible to control it using both units 29, 33.

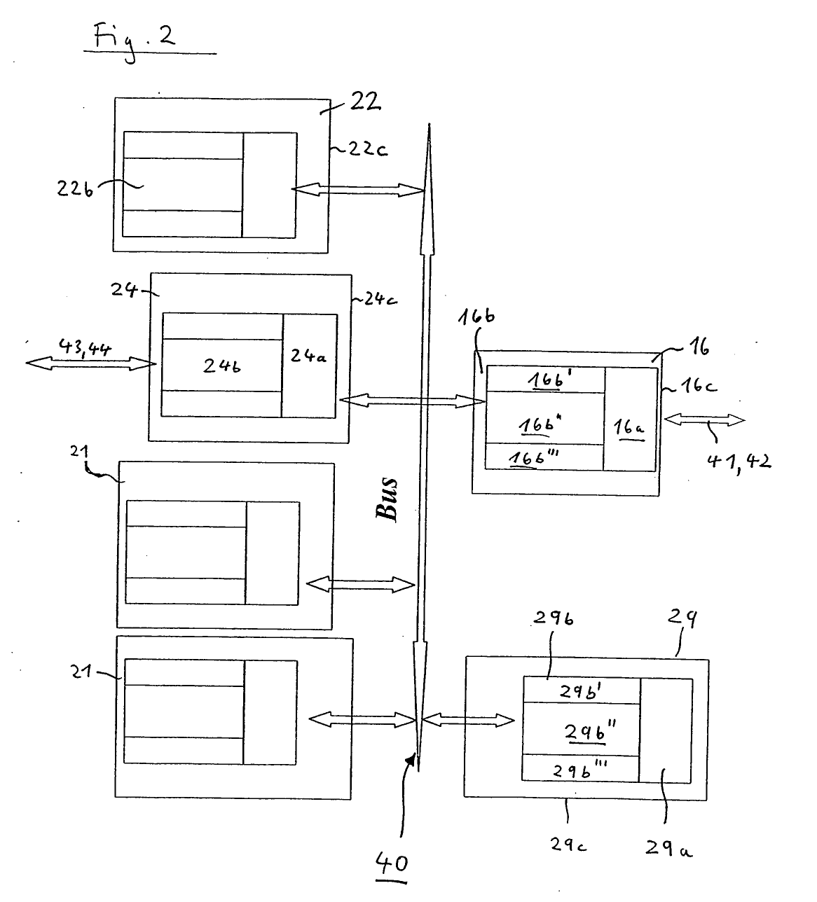

As already mentioned, the individual functional units of the microscope 10 and the external elements 29, 33 are connected to one another by a bus system. The bus system may be, for example, a CAN system. A bus system of this kind is shown in FIG. 2 and generally designated 40. Using a bus system of this kind, standardized transmission of data between the individual functional units of the microscope can easily be carried out. The bus system may be constructed as a simple bus system in which various kinds of information such as data, control signals or addresses are serially transmitted through the same lines. It is also possible to design it as a multiple bus system with a plurality of individual bus systems through which information of a particular kind is transmitted.

FIG. 2 shows, in particular, the functional units shown in FIG. 1, namely the motor driven focus 16, fluorescence module 22 and motor driven zoom 24. Another functional unit is the control unit 29 which, as already mentioned, is also connected to the bus system.

Other components which may be connected to the bus system 40 are, for example, a functional unit for adjusting the shutter and a hand wheel. Although not shown in FIG. 1, a “display” functional unit for displaying system-specific data may also be attached. In order to illustrate the possibility of equipping a microscope with any desired functional units of this kind, FIG. 2 shows two other functional units, bearing reference numeral 21.

The operating element 29 communicating directly with the bus system allows particularly easy and effective control of all the functional units with one hand. Unlike conventional solutions, there is no need for several operating elements. Thus, the number of components of the microscope can be effectively reduced compared with conventional solutions.

FIG. 2 also diagrammatically shows the structure of the individual functional units. The letter “a” denotes a microcontroller, and “b” a memory device b associated with the microcontroller a. The various functional units also have an actor which is shown purely diagrammatically as a frame surrounding the microcontroller and the memory device, and is designated “c”. It is also possible to connect the functional units to other applications (not shown) by means of other bus systems. This is illustrated by way of example in FIG. 2 by the double arrows 41-44, and these may be, for example, a Universal Serial Bus (USB) or an IEEE Bus (“Firewire”), particularly using an RS232 port.

The arrangement shown will be explained in detail with reference to the example of the motor driven focus 16. The motor driven focus 16 has a microcontroller 16a and a memory device 16b. The memory device 16b is sub divided into a first region 16b′ in which boot strap software and optionally an operating system is stored. A second region 16b″ contains control software for the motor focus in a current version. Finally, the third region 16b′″ contains calibration data which are needed or useful for operating the motor driven focus within the scope of the microscope according to the invention.

The other functional units shown are similar in structure and there is therefore no need to provide a detailed description here of the microcontrollers or memory devices used. For instance, the control unit 29 is a functional unit that is shown as including a microcontroller 29a, a memory device 29b including the memory regions 29b′, b″ and b′″ and an actor 29c are explicitly designated. The first region 29b′ of memory device 29b stores a bootstrap loader software program or custom boot loader.

According to the invention, using the boot strap loader software provided, installation software can easily be downloaded into the microcontroller of the control unit. This installation software then makes it easy to carry out a purely software-related update of the software or firmware of the microcontroller of the control unit, thereby verifying or defining the operating elements, particularly the operating wheels or operating keys or operating ball.

It is particularly easy according to the invention to download an update of the control software for the functional units into the respective memory regions b″. This will be explained again with reference to the motor driven focus 16.

The boot strap loader software contained in the memory region 16b′ is a relatively small program by means of which more extensive software applications can be loaded into the respective memory regions, i.e. in this instance the control software region 16b″. All that is required is to activate the boot strap loader program by means of a corresponding input command which can be fed into the system through the computer 33, for example. Then, an updated version of the control software for the motorized focus 16, which is also loaded into the computer 33, for example, can be downloaded into the region 16b″ of the memory device 16b.

In contrast to conventional solutions there is no need to open a function control unit in order to update the software.

Installation software used in conjunction with the boot strap loader software described is capable of automatically recognizing any motorized functional unit of the microscope. By means of the customized boot loader used according to the invention and an arbitrary bus, the corresponding application software or any necessary or desirable update can be run, and this can be done automatically or interactively.

The regions b′ and b′″ are preferably constructed as protected memory regions.

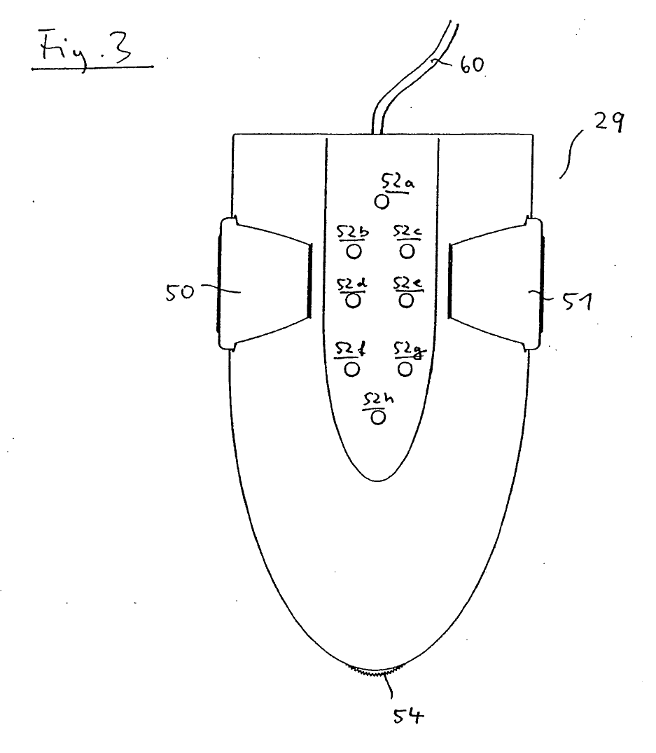

A preferred embodiment of the control unit 29 according to the invention is shown in FIG. 3. The control unit 29 here is provided in the form of a computer mouse.

Two operating wheels 50, 51 and a number of operating buttons or keys 52a to 52h are shown. Although these operating wheels or keys can be assigned any desired functions, a preferred assignment option will now be described. The operating wheels 50, 51, 52 are easily accessible to the user from above, being formed in the side portions of the operating element 29. It is preferable for the operating wheel 50 to be used for fine adjustment of the motorized focus 16. Any coarse adjustment needed can be done by actuating at least one of the keys 52a to 52h. The operating wheel 51 is expediently used to adjust the motorized zoom 24, while again fine adjustment can be made using the operating wheel 51 and corresponding coarse adjustment is done by actuating at least one of the keys 52a to 52h.

Finally, FIG. 3 shows a third operating wheel 54 which is arranged in the rear part of the control unit. This operating wheel 54 is preferably used for incrementally controlling an iris shutter.

Particular positions of the microscope can be stored using at least one key, e.g. the key 52a. This key can also be used as a toggle to switch between specific positions stored in the memory.

The control unit 29 can be connected to the bus 40 via a lead 60 (see also FIG. 1) or in wireless manner.

It should be pointed out that all the functional units described with reference to FIGS. 1 and 2 may usefully be controlled by suitably actuating the keys 52a to 52h.

The integration of operating wheels or rotary wheels 50, 51, the operating wheel or knurled ring 54 and the keys 52a to 52h in only one control unit and the particular arrangement thereof allows all the functional units to be controlled with one hand, without the operator having to lift his hand away from the control unit. The easy software update allows individual assignment of the operating elements depending on the equipping of the apparatus, and particularly according to the functional units or components of the microscope which are present or in accordance with the user's wishes, while in particular allowances can be made for right or left handed operation.

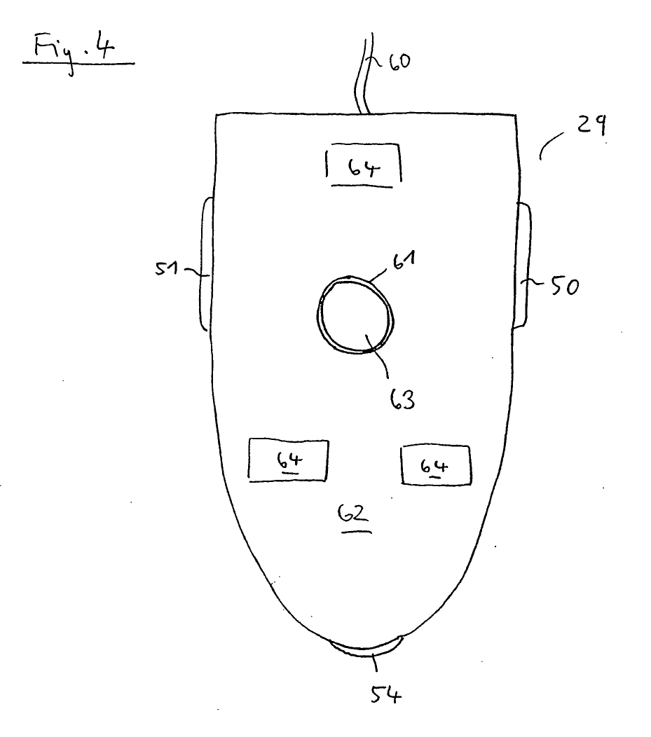

Finally, reference is made to FIG. 4 which shows a view of the control unit according to FIG. 3 seen from below. It shows the operating wheels 50, 51 and 54 which have already been described with reference to FIG. 3. In the baseplate 62 of the control unit 29 is a recess 61 in which an operating ball 63 is disposed. The operating ball 63 projects from the baseplate 62 so that when the baseplate is moved over a substrate (“like a mouse”) it can perform a rotary movement by which a functional unit of the microscope, particularly an X-Y stage, can be actuated. of course, other means for detecting relative motion between the control unit and the substrate may be used, for example a proximity sensor, capacitive switch, optical sensor, or the like. The combination of an operating element provided on the underside of the control unit with the plurality of operating elements on the upper surface of the control unit, as described in detail with reference to FIG. 3, enables total control of all the essential motorized functional units of a microscope. FIG. 4 also shows magnets 64 set into the baseplate 62 which constitute a magnetic holder for the control unit to secure it to a microscope.

### LIST OF REFERENCE NUMERALS

10 Microscope
12 Optical system carrier
14 Optical system
13 Base
13a Motorized X-Y stage
16 Motorized focusing device, motorized focus
a denotes a microcontroller
b denotes a memory device
c denotes an actor
16a Microcontroller
16b Memory device
16b′ First region of the memory device
16b″ Second region, control software region, of the memory device
16b′″ Third region of the memory device
17 Stand
20 Eyepiece
21 Other functional units
22 Fluorescence module
24 Motorized zoom
26 objective (lens)
28 objective (lens)
29 Manually actuated control unit
29a Microcontroller of the control unit
29b Memory device of the control unit
29b′, b″, b′″ Memory regions
29c Actor of the control unit
30 objective (lens)
32 Lighting device
33 Computer
34 Universal port
40 Bus system
41-44 Double arrows
50, 51 Operating wheels
52a-52h Operating buttons or keys
54 Third operating wheel, knurled ring
60 Wire
61 Recess
62 Baseplate, control unit base
63 Operating ball, element
64 Magnets

1. A manually actuated control unit for actuating or controlling a plurality of other functional units of a microscope, the control unit comprising:
a microcontroller;
at least one operating element for providing control commands to the microcontroller for actuating or controlling the plurality of functional units; and
a memory device associated with the microcontroller, wherein the memory device includes a first memory region and a second memory region, the first memory region storing boot loader programming instructions executable to load control programming instructions into the second memory region, the control programming instructions defining a function of the at least one operating element.

2. The control unit according to claim 1, wherein the at least one operating element includes an operating wheel.

3. The control unit according to claim 1, wherein the at least one operating element includes an operating key.

4. The control unit according to claim 1, wherein the at least one operating element includes an operating ball.

5. The control unit according to claim 1, further comprising a lighting element for illuminating the control unit.

6. The control unit according to claim 1, further comprising a ring buffer device for storing user settings of the functional units for at least one user.

7. The control unit according to claim 1, wherein the at least one operating element includes an motion-sensitive operating element provided in a base surface of the control unit such that movement of the control unit over a substrate brings about actuation of the motion-sensitive operating element.

8. The control unit according to claim 7, wherein the motion-sensitive operating element can be selectively coupled with an X-Y stage of a microscope such that movement of the control unit produces corresponding movement of the X-Y stage.

9. The control unit according to claim 1, further comprising a magnetic holding device for removably attaching the control unit to a microscope.

10. The control unit according to claim 1, wherein all of the operating elements can be operated manually without removing the hand from the control unit.

11. The control unit according to claim 10, wherein the control unit is constructed in the manner of a computer mouse.

12. A microscope comprising:
a plurality of functional units including a control unit for actuating or controlling other functional units in the plurality of functional units; and
a bus system by which the control unit communicates with the other functional units;
wherein the control unit comprises:
a microcontroller;
at least one operating element for providing control commands to the microcontroller for actuating or controlling the plurality of functional units; and
a memory device associated with the microcontroller, wherein the memory device includes a first memory region and a second memory region, the first memory region storing boot loader programming instructions executable to load control programming instructions into the second memory region, the control programming instructions defining a function of the at least one operating element.

13. The microscope according to claim 12, wherein the bus system is a CAN bus system.
